(19) United States
(12) Patent Application Publication
(10) Pub. No.: US 2011/0093902 A1
(43) Pub. Date: Apr. 21, 2011

(54) System and Method to Process a Data Stream Having Different Content Types

(75) Inventors: Gustavo De Los Reyes, Fair Haven, NJ (US); Sanjay Macwan, Marlboro, NJ (US); Jennifer Morovitz, Ballwin, MO (US)

(73) Assignee: AT&T INTELLECTUAL PROPERTY I, L.P., Reno, NV (US)

(21) Appl. No.: 12/580,332

(22) Filed: Oct. 16, 2009

(51) Int. Cl. H04N 7/18; H04N 7/173

(52) U.S. Cl. 725/80; 725/82; 725/110; 725/106; 370/352

(57) ABSTRACT

A computer-implemented method includes receiving a data stream at a set-top box device from a residential gateway. The data stream includes first data having a first content type, second data having a second content type, and third data having a third content type. The method includes assigning the first data for processing at a first machine of the set-top box device. The method also includes assigning the second data for processing at a second machine of the set-top box device. The method further includes assigning the third data for processing at a third machine of the set-top box device. The set-top box device is configured to selectively output at least one of the first data, the second data, and the third data for display at a display device.

### FIELD OF THE DISCLOSURE

The present disclosure is generally related to processing a data stream having different content types.

### BACKGROUND

A service provider may provide multiple services, such as access to media content, telephony service, and internet access, to subscribers. Access to the media content and to the telephony service are often separated from the internet access. This may be done to prevent malicious applications (e.g. viruses, spyware, and malware) that may be inadvertently downloaded from the internet from affecting access to the media content and access to the telephony service. As the lines between access to media content, telephony service, and internet access blur, subscribers may elect to access multiple services via any device available to the subscriber. Such access may lead to resource contention and security issues.

### BRIEF DESCRIPTION OF THE DRAWINGS

FIG. 1 is a block diagram of a first particular embodiment of a system to process a data stream having different content types;

FIG. 2 is a block diagram of a second particular embodiment of a system to process a data stream having different content types;

FIG. 3 is a block diagram of a third particular embodiment of a system to process a data stream having different content types;

FIG. 4 is a flow diagram of a first particular embodiment of a method to process a data stream having different content types;

FIG. 5 is a flow diagram of a second particular embodiment of a method to process a data stream having different content types; and

FIG. 6 is a block diagram of an illustrative embodiment of a general computer system.

### DETAILED DESCRIPTION

A data stream is received at a device from a residential gateway. The data stream includes first data having a first content type, second data having a second content type, and third data having a third content type. The first data is assigned to a first machine for processing. The second data is assigned to a second machine for processing. The third data is assigned to a third machine for processing. The device is configured to selectively output at least one of the first data, the second data, and the third data for display at a display device.

In a particular embodiment, a computer-implemented method includes receiving a data stream at a set-top box device from a residential gateway. The data stream includes first data having a first content type, second data having a second content type, and third data having a third content type. The method includes assigning the first data for processing at a first machine of the set-top box device. The method also includes assigning the second data for processing at a second machine of the set-top box device. The method further includes assigning the third data for processing at a third machine of the set-top box device. The set-top box device is configured to selectively output at least one of the first data, the second data, and the third data for display at a display device.

In another particular embodiment, a display device includes at least one processor, a memory coupled to the at least one processor, a plurality of virtual machines executing at the at least one processor, and an input interface configured to receive a data stream including a plurality of data packets. Each data packet includes a header and a payload. The header identifies the payload as including one of a plurality of content types. A management module is stored at the memory. The management module is executable by the at least one processor to assign a first content type of the plurality of content types to a first virtual machine of the plurality of virtual machines and assign a second content type of the plurality of content types to a second virtual machine of the plurality of virtual machines. The display device also includes an output interface configured to selectively output at least one of the content types to a display screen.

In another particular embodiment, a computer-readable storage medium includes operational instructions, that when executed by at least one processor, cause the at least one processor to receive a data stream including a plurality of data packets. Each data packet includes a header and a payload. The header identifies the payload as including one of a plurality of content types. The operational instructions are executable by the at least one processor to filter the data stream into a plurality of sub-streams based on the content type identified in each of the headers of the data packets. The operational instructions are further executable by the at least one processor to execute a first sub-stream at a first machine. The first sub-stream has a voice telephony content type. The operational instructions are further executable by the at least one processor to execute a second sub-stream at a second machine. The second sub-stream has an Internet Protocol television (IPTV) content type. The operational instructions are further executable by the at least one processor to selectively send output of the first sub-stream and the second sub-stream to a display device.

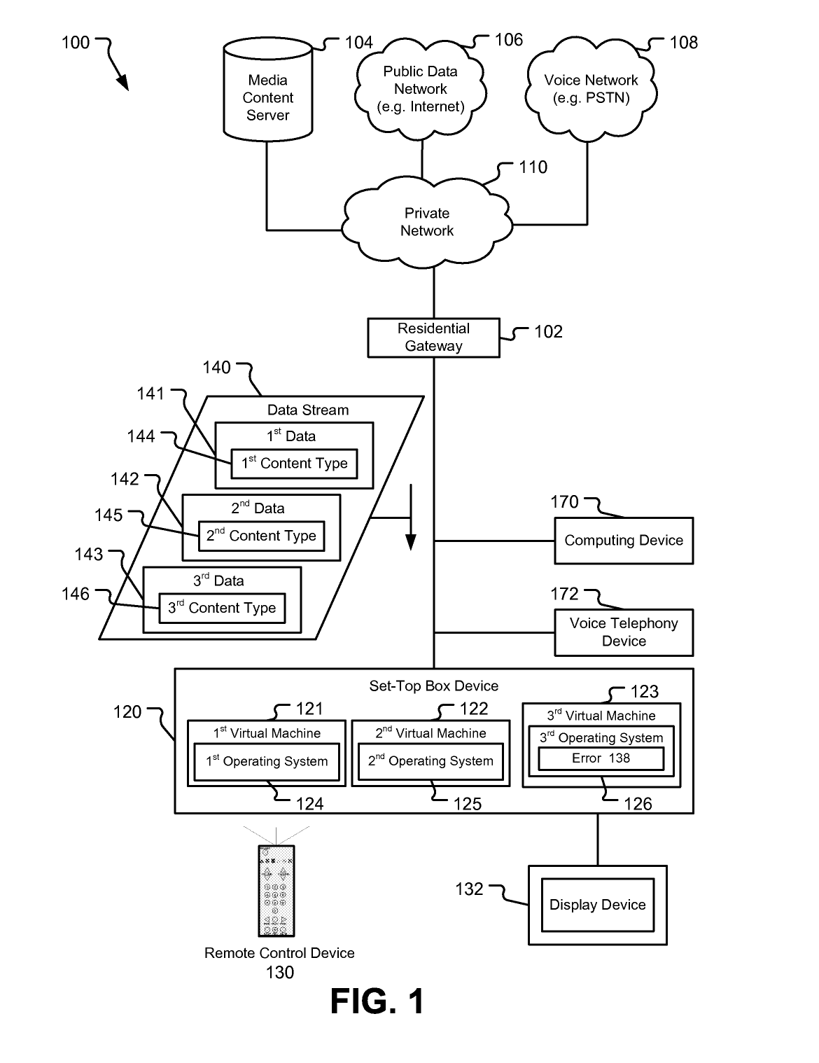

Referring to FIG. 1, a block diagram of a first particular embodiment of a system to process a data stream having different content types is depicted and generally designated 100. The system 100 includes a residential gateway 102 coupled to a media content server 104, a public data network 106, and a voice network 108 via a private network 110. A set-top box device 120, a computing device 170, and a voice telephony device 172 are coupled to the residential gateway 102. A display device 132 is coupled to the set-top box device 120. A remote controlled device 130 may be used to wirelessly interact with the set-top box device 120.

The media content server 104 may provide access to media content, such as television content, movie content, video on demand content, other media content, or any combination thereof to devices coupled to the residential gateway 102. For example, the set-top box device 120 may access media content at the media content server 104 via the residential gateway 102 and display the media content at the display device 132.

The public data network 106 may provide access to internet content via a software application such as an internet browser. The residential gateway 102 may enable the set-top box device 120, the computing device 170, and the voice telephony device 172 to place and receive voice telephony calls via the public data network 106. For example, the residential gateway 102 may enable the voice telephony device 172 coupled to the residential gateway 102 to place and receive Voice over Internet Protocol (VoIP) calls via the public data network 106 and via the voice network 108. The residential gateway 102 may enable the computing device 170 to access web content via the public data network 106. The residential gateway 102 may enable the set-top box device 120 to receive media content from the media content server 104.

The voice network 108 may include a Public Switched Telephone Network (PSTN), a wireless network, another voice network, or any combination thereof. The residential gateway 102 may enable the set-top box device 120, the computing device 170, and the voice telephony device 172 to place and receive voice telephony calls to the voice network 108. The voice network 108 may use various standards, including Code Division Multiple Access (CDMA), Global System for Mobile (GSM), Universal Mobile Telephone Service (UMTS), Institute of Electrical and Electronic Engineers (IEEE) 802.11, other standards, or any combination thereof.

The private network 110 may be a network provided by a service provider to subscribers. For example, the private network 110 may include an IPTV access network, a cable network, a satellite network, another media content delivery network, or any combination thereof. The private network 110 may be based on an Internet Protocol (IP) standard, a Data Over Cable Service Interface Specification (DOCSIS) standard, a Hybrid Fiber Coaxial (HFC) standard, another standard, or any combination thereof.

The residential gateway 102 may be used as a gateway to connect devices in a home to the media content server 104, the public data network 106, the voice network 108, another network (not shown), or any combination thereof. For example, the residential gateway 102 may be used by the set-top box device 120, the display device 132, the computing device 170, and the voice telephony device 172 to view media content received from the media content server 104, to access the public data network 106 (e.g. the Internet), and to place and receive voice telephony calls to the voice network 108.

The set-top box 120 may access media content from the media content server 104, access the internet via the public data network 106, and access voice telephony services via the voice network 108. In a particular embodiment, the set-top box device 120 includes a plurality of virtual machines, such as a first virtual machine 121, a second virtual machine 122, and a third virtual machine 123. While only the set-top box device 120 is depicted as having the virtual machines 121-132, the display device 132, the computing device 170, and the voice telephony device 172 may also have one or more virtual machines. The first virtual machine 121 may execute a first operating system 124. The second virtual machine 122 may execute a second operating system 125. The third virtual machine 123 may execute a third operating system 126. Each of the virtual machines 121-123 may be optimized to process a particular type of content. For example, the first virtual machine 121 may be optimized to process media content, the second virtual machine 122 may be optimized to process web content, and the third virtual machine 123 may be optimized to process voice telephony content.

In operation, a data stream 140 may be received at the set-top device box 120 from the residential gateway 102. The data stream 140 may include various content types and each content type of the data stream 140 may be assigned for processing to one or more of the virtual machines 121-123. The data stream 140 may include first data 141, second data 142, and third data 143. The first data 141, the second data 142, and the third data 143 may include various content types. For example, the first data 141 may include a first content type 144, the second data 142 may include a second content type 145, and the third data 143 may include a third content type 146. To illustrate, the first content type 144 may be a voice telephony content type (e.g. VoIP), the second content type 145 may be a multimedia content type, such as Motion Picture Experts Group (MPEG) encoded content type, and the third content type 146 may be an internet browser content type, such as a Hypertext Mark-up Language (HTML) content type or other internet browser content type.

After receiving the data stream 140 at the set-top box device 120, the first data 141 may be assigned to the first virtual machine 121 for processing, the second data 142 may be assigned to the second virtual machine 122 for processing, and the third data 143 may be assigned to the third virtual machine 123 for processing. The set-top box device 120 may be configured to selectively output at least one of the first data 141, the second data 142, and the third data 143 for display at the display device 132.

The set-top box device 120 may detect an error 138 while executing one of the virtual machines 121-123 or executing one of the operating systems 124-126, such as the third operating system 126 at the third virtual machine 123. Although the error 138 is depicted as occurring at the third virtual machine 123 in FIG. 1, the error 138 may occur at any one of the virtual machines 121-123 or the operating systems 124-126. After detecting the error 138 at the third virtual machine 123, the set-top box device 120 may correct the error 138 without affecting the virtual machines 121-122 that are processing other portions of the data stream 140. To illustrate, the set top device 120 may correct the error 138 by restarting the third operating system 126, by removing an application associated with the error 138 from the third virtual machine 123, or by killing a process executing at the third virtual machine 123 that is associated with the error 138. To illustrate, the first virtual machine 121 may process voice telephony content (e.g. VoIP content), the second virtual machine 122 may process media content (e.g. IPTV content), and the third virtual machine 123 may process browser content (e.g. HTML). When a user browsing the public data network 106 encounters a malicious application (e.g. virus) that causes the error 138, the error 138 does not affect the first virtual machine 121 and does not affect the second virtual machine 122. The error 138 can be corrected without affecting the first virtual machine 121 and the second virtual machine 122 and without interrupting media content service and voice telephony service that are available to a subscriber via the residential gateway 102

Thus, by using the virtual machines 121-123 to process the content types 144-146, when the error 138 is encountered by one of the operating systems 124-126, the error is isolated and can be dealt with out affecting processing of the other content types. For example, in FIG. 1, the error 138 can be corrected at the third virtual machine 123 without affecting the processing of the first content type 144 at the first virtual machine 121 and without affecting the processing of the second content type 145 at the second virtual machine 122.

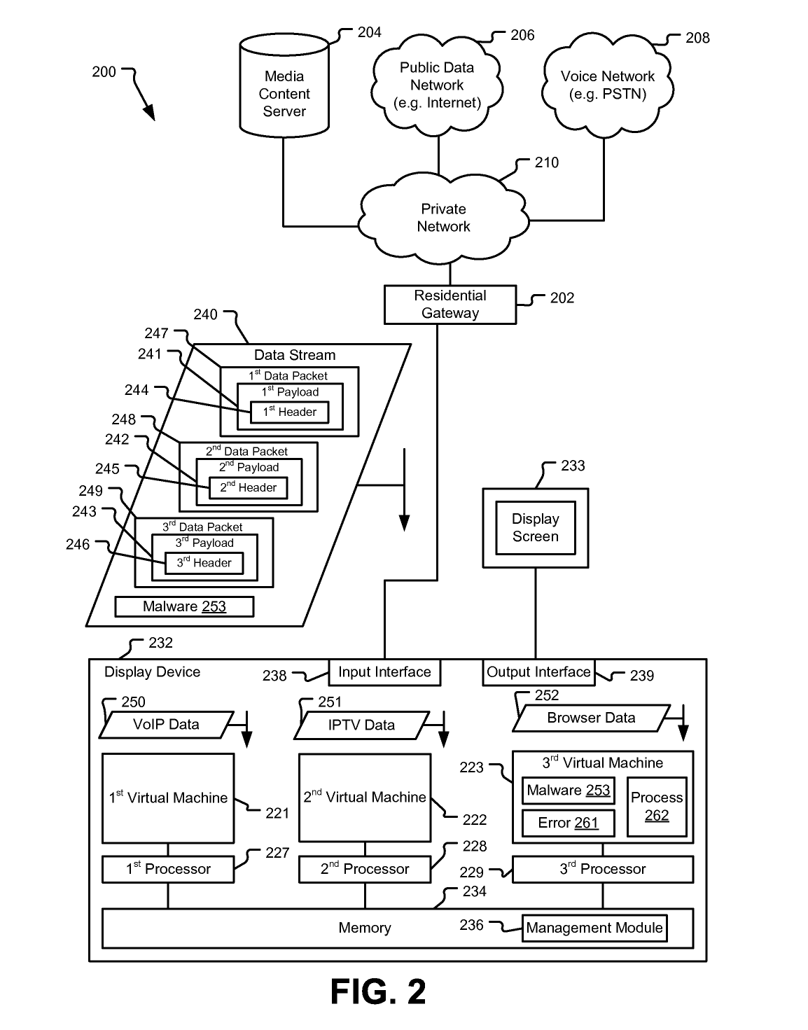

Referring to FIG. 2, a block diagram of a second particular embodiment of a system to process a data stream having different content types is depicted and generally designated 200. The system 200 includes a residential gateway 202 coupled to a media content server 204, a public data network 206, and a voice network 208 via a private network 210. A display device 232 is coupled to the residential gateway 202. A display screen 233 is coupled to or integrated with the display device 232.

The media content server 204 may provide access to media content, such as television content, movie content, video on demand content, other media content, or any combination thereof to devices coupled to the residential gateway 202. For example, the display device 232 may access media content at the media content server 204 via the residential gateway 202 and display the media content at the display screen 233.

The public data network 206 may enable access to internet content via a software application executing at the display device 232. For example, an internet browser executing at the display device 232 may enable a user to browse and access internet content at the public data network 206.

The voice network 208 may be a Public Switched Telephone Network (PSTN), wireless network, another voice network, or any combination thereof. The residential gateway 202 may enable the display device 232 to place and receive voice telephony calls to the voice network 208. The voice network 208 may use various standards, such as Code Division Multiple Access (CDMA), Global System for Mobile (GSM), Universal Mobile Telephone Service (UMTS), Institute of Electrical and Electronic Engineers (IEEE) 802.11, another standard, or any combination thereof.

The private network 210 may be a network provided by a service provider to subscribers. For example, the private network 210 may include an IPTV access network, a cable network, a satellite network, another media content delivery network, or any combination thereof. The private network 210 may be based on an Internet Protocol (IP) standard, a Data Over Cable Service Interface Specification (DOCSIS) standard, a Hybrid Fiber Coaxial (HFC) standard, another standard, or any combination thereof.

The residential gateway 202 may be used as a gateway to connect the display device 232 to the media content server 204, the public data network 206, the voice network 208, another network (not shown), or any combination thereof. For example, the display device 232 may be used to view media content received from the media content server 204, to access the public data network 206, and to place and receive voice telephony calls to the voice network 208.

The display device 232 includes an input interface 238, an output interface 239, a memory 234, and one or more processors, such as a first processor 227, a second processor 228, and a third processor 229. A first virtual machine 221, a second virtual machine 222, and a third virtual machine 223 may execute at one or more of the processors 227-229. As depicted in FIG. 2, the first virtual machine 221 executes at the first processor 227, the second virtual machine 222 executes at the second processor 228, and the third virtual machine 223 executes at the third processor 229. The memory 234 includes a management module 236. The management module 236 is operable to manage the virtual machines 221-223. For example, the management module 236 may assign a particular content type for processing at one of the virtual machines 221-223. The management module 236 may detect and correct any error occurring at the virtual machines 221-223.

In operation, the input interface 238 may receive a data stream 240 from the residential gateway 202. The data stream 240 may include a first data packet 247, a second data packet 248, and a third data packet 249. The first data packet 247 may include a first payload 241 and a first header 244. The second data packet 248 may include a second payload 242 and a second header 245. The third data packet 249 may include a third payload 243 and a third header 246. The headers 244-246 may identify the payloads 241-243 as including a particular content type. For example, the first header 244 may identify the first payload 241 as having a voice telephony (e.g. VoIP) content type, an IPTV content type, a media content type (e.g. MPEG or H.264), a browser content type (e.g. HTML), or any combination thereof. The management module 236 may identify the content type of the payloads 241-243 based on the headers 244-246 and assign one or more of the payloads 241-243 for processing at one or more of the virtual machines 221-223 based on the identified content type. For example, the management module 236 may identify the first payload 241 as having a VoIP content type based on the first header 244 and assign VoIP data 250 for processing at the first virtual machine 221. The management module 236 may identify the second payload 242 as having an IPTV content type based on the second header 245 and send IPTV data 251 to the second virtual machine 222 for processing. The management module 236 may identify the third payload 243 as having a browser content type based on the third header 245 and send browser data 252 to the third virtual machine 223 for processing. The VoIP data 250 may correspond to the first payload 241, the IPTV data 251 may correspond to the second payload 242, and the browser data may correspond to the third payload 243.

A subscriber may select one or more of the VoIP data 250, the IPTV data 251, and the browser data 252 to send to the output interface 239 for display at the display screen 233. For example, the subscriber may select to send a television program (e.g. IPTV data 251) while simultaneously displaying web content (e.g. browser data 252) at the display screen 233. The subscriber may select to send telephony data, such as incoming/outgoing numbers and caller identification information, to the display screen while sending the IPTV data 251 and the browser data 252 to the display screen 233. For example, the output interface 239 may be configured to selectively output at least one of the content types of the data packets 247-249 to the display screen 233 after the data packets 247-249 have been processed at the virtual machines 221-223. To illustrate, the output interface 239 may selectively output the VoIP data 250 to the display screen 233 after the first virtual machine 221 has processed the VoIP data 250. The output interface 239 may selectively output the IPTV data 251 to the display screen 233 after the second virtual machine 222 has processed the IPTV data 251. The output interface 239 may selectively output the browser data 252 to the display screen 233 after the third virtual machine 223 has processed the browser data 252. The display screen 233 may be a liquid crystal display (LCD), plasma, another type of display, or any other combination thereof.

The management module of 236 may be operable to detect errors during processing of data by one or more of the virtual machines 221-223. For example, the management module 236 may detect an error 261 at the third virtual machine 223. Although the error 261 is depicted as occurring at the third virtual machine 223 in FIG. 2, the error 261 may occur at any one of the virtual machines 221-223. The error 261 may be related to malware 253 received at the virtual machine 223 via the data stream 240. The malware 253 may be a malicious application, a virus, a tracking cookie, another malicious application, or any combination thereof. The management module 236 may correct the error 261 detected at the third virtual machine 223 without affecting the other virtual machines 221-222. For example, management module 236 may reboot or restart the third virtual machine 223 to clear the error 261. In another example, the management module 236 may correct the error 261 detected at the third virtual machine 223 by removing the malware 253 from the third virtual machine 223. In yet another example, the management module 236 may correct the error 261 by terminating at least one executing process 262 within the third virtual machine 223 without restarting the virtual machine 223.

Thus, the management module 236 may identify a content type of the payloads 241-243 based on the headers 244-246 and assign the data 250-252 to the virtual machines 221-223 for processing based on the content type. The management module 236 may also detect errors that occur at one of the virtual machines 221-223 and correct the detected errors without affecting the other virtual machines. For example, the management module 236 can detect and remove the error 261 without affecting voice telephony services (e.g. VoIP data 250) and without affecting access to media content (e.g. IPTV data 251).

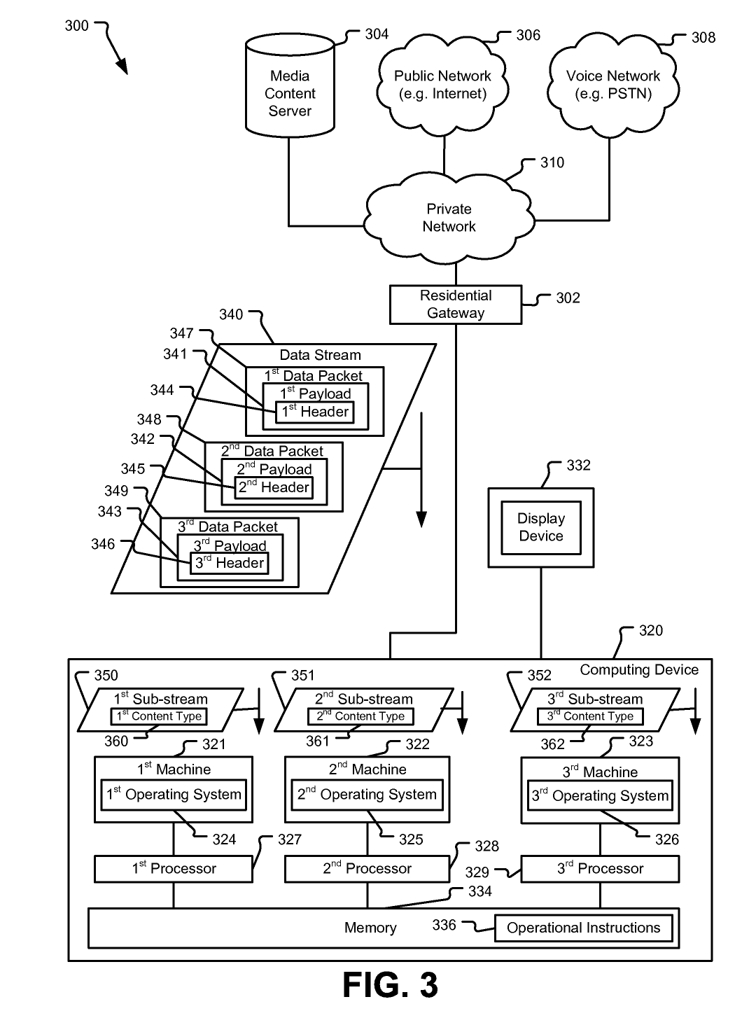

Referring to FIG. 3, a block diagram of a third particular embodiment of a system to process a data stream having different content types is depicted and generally designated 300. In the system 300, a media content server 304, a public data network 306, and a voice network 308 are coupled to a residential gateway 302 via a private network 310. Coupled to the residential gateway 302 is a computing device 320. A display device 332 is coupled to the computing device 320.

The media content server 304 may provide access to media content, such as television content, movie content, video on demand content, other media content, or any combination thereof to devices coupled to the residential gateway 302. For example, the computing device 320 may access media content at the media content server 304 via the residential gateway 302 and display the media content at the display device 232.

The public data network 306 may enable access to internet content via a software application executing at the computing device 320. For example, an internet browser executing at the computing device 320 may enable a user to browse and access internet content at the public data network 306.

The voice network 308 may be a Public Switched Telephone Network (PSTN), wireless network, another voice network, or any combination thereof. The residential gateway 302 may enable the computing device 320 to place and receive voice telephony calls to the voice network 308. The voice network 308 may use various standards, such as Code Division Multiple Access (CDMA), Global System for Mobile (GSM), Universal Mobile Telephone Service (UMTS), Institute of Electrical and Electronic Engineers (IEEE) 802.11, another standard, or any combination thereof.

The private network 310 may be a network provided by a service provider to subscribers. For example, the private network 310 may include an IPTV access network, a cable network, a satellite network, another media content delivery network, or any combination thereof. The private network 310 may be based on an Internet Protocol (IP) standard, a Data Over Cable Service Interface Specification (DOCSIS) standard, a Hybrid Fiber Coaxial (HFC) standard, another standard, or any combination thereof.

The residential gateway 302 may be used as a gateway to connect the computing device 320 to the media content server 304, the public data network 306, the voice network 308, another network (not shown), or any combination thereof. For example, the computing device 320 may be used to view media content received from the media content server 304, to access the public data network 306, and to place and receive voice telephony calls to the voice network 308.

The computing device 320 may include one or more machines, such as a first machine 321, a second machine 322, and a third machine 323. Each of the machines 321-323 may be virtual machines, hardware computing machines, or any combination thereof. For example, when the machines 321-323 are hardware computing machines, each of the machines may have a separate hardware circuit board, with each circuit board having one or more processors. Each of the machines 321-323 may be associated with a processor, such as a first processor 327, a second processor 328, a third processor 329, and a memory 334. The first machine 321 may be associated with the first processor 327, the second machine 322 may be associated with the second processor 328, and the third machine 323 may be associated with the third processor 329. The first machine 321 may execute a first operating system 324, the second machine 322 may execute a second operating system 325, and the third machine 323 may execute a third operating system 326. The operating systems 324-326 may be the same operating system or at least one of the operating systems 324-326 may be different from the another operating system. In a particular embodiment, the first operating system 324 may be different than the second operating system 325 and different than the third operating system 326. The operating systems 324-326 may include a Unix operating system, a Unix-like operating system (e.g. Linux), a Windows operating system, another operating system, or any combination thereof. The memory 334 includes operational instructions 336 that may be executed by one or more of the processors 327-329 to perform various functions of the computing device 320 and to manage the machines 321-323. For example, the operational instructions 336 may be executed by one or more of the processors 327-329 to assign a particular content type for processing at one of the machines 321-323.

In operation, the computing device 320 may receive a data stream 340 from the residential gateway 302. The data stream 340 may include one or more packets, with each packet including a particular type of content. For example, the data stream 340 may include voice telephony content, media content, web content, another type of content, or any combination thereof. In FIG. 3, the data stream 340 is depicted as including a first data packet 347, a second data packet 348, and a third data packet 349. The first data packet 347 may include a first header 344 and a first payload 341. The second data packet 348 may include a second header 345 and a second payload 342. The third data packet 349 may include a third header 346 and a third payload 343. The headers 244-246 may identify a type of content of the payloads 241-243.

The operational instructions 336 may be executed by one or more of the processors 327-329 to filter the data stream 340 into different sub-streams based on a content type of each of the data packets 247-249. For example, the data stream 240 may be filtered into a first sub-stream 350, a second sub-stream 351, and a third sub-stream 352 based on a content type of the payloads 341-343. The headers 344-346 may identify a content type of the data packets 347-349. For example, the first header 344 may identify the first payload as having a first content type 360 (e.g. VoIP). The second header 345 may identify the second payload 342 as having a second content type 361 (e.g. MPEG). The third header 346 may identify the third payload 343 as having a third content type 362 (e.g. HTML). The data stream 340 may be filtered into the sub-streams 350-352 based on the content types 360-362.

The operational instructions 336 may be executed by one or more of the processors 327-329 to assign each of the sub-streams 350-352 for processing to one or more of the machines 321-323. For example, the first sub-stream 350 may be assigned for processing to the first machine 321, the second sub-stream 351 may be assigned for processing to the second machine 322, and the third sub-stream 352 may be assigned for processing to the third machine 323. The output of at least one of the sub-streams 350-352 may be selectively output to the display device 332. For example, a subscriber may select one or more of voice telephony data (e.g. VoIP caller identification data), media content (e.g. television programs, movies, or video-on-demand data delivered via IPTV), and web content (e.g. HTML data) for display at the display device 332.

Thus, the operational instructions 336 may be executed by one or more of the processors 327-329 to identify a content type of the payloads 341-343 based on the headers 344-346 and to filter the data stream 340 to create the sub-streams 350-352. The operational instructions 336 may be executed by one or more of the processors 327-329 to assign the sub-streams 350-352 to the machines 321-323. The operational instructions 336 may be executable one or more of the processors 327-329 to detect and correct a problem occurring at one of the machines 321-323 without affecting the other machines. For example, a problem occurring at the third machine 323 may be detected and corrected without affecting the processing of the first sub-stream 350 at the first machine 321 and without affecting the processing of the second sub-stream 351 at the second machine 322.

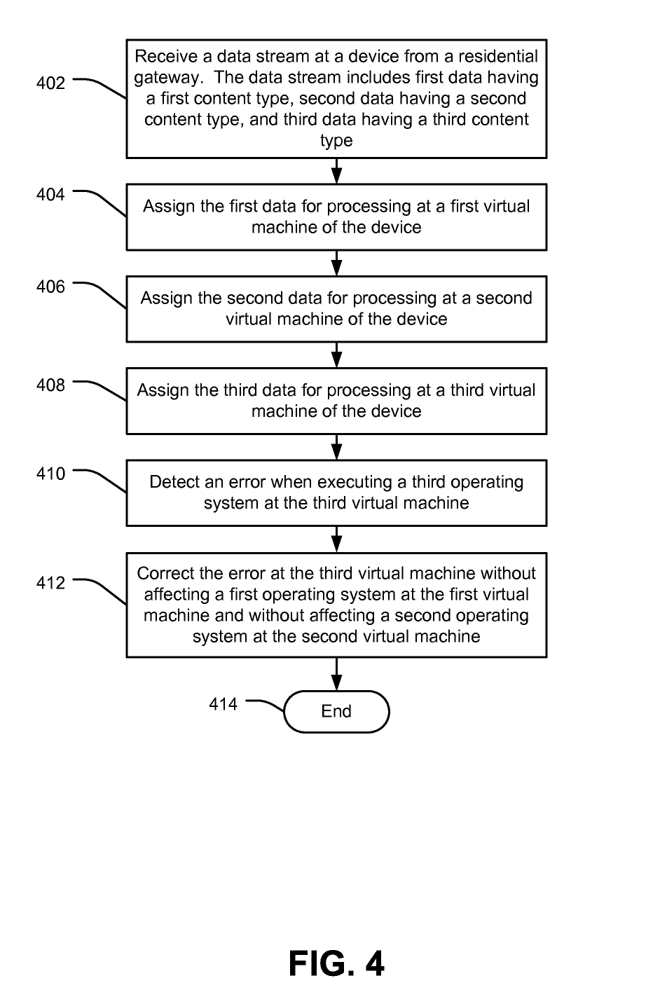

Referring to FIG. 4, a flow diagram of a first particular embodiment of a method to process a data stream having different content types is depicted. The method of FIG. 4 may be performed by a device, such as the set-top box device 120 of FIG. 1, the display device 232 of FIG. 2, or the computing device 320 of FIG. 3.

A data stream is received at a device from a residential gateway. The data stream may include data having different content types, such as first data having a first content type, second data having a second content type, and third data having a third content type. Moving to 404, the first data may be assigned for processing at a first virtual machine of the device. Advancing to 406, the second data may be assigned for processing at a second virtual machine of the device. Proceeding to 408, the third data may be assigned for processing at a third virtual machine of the device. For example, in FIG. 1, the data stream 140 may be received at the set-top box device 120. The first data 141, having a first content type 144, may be assigned to the first virtual machine 121. The second data 142, having a second content type 145, may be assigned to the second virtual machine 122. The third data 143, having the third content type 146, may be assigned to the third virtual machine 123.

Moving to 410, an error may be detected when executing one of the virtual machines or one of the operating systems. For example, an error may be detected when executing the third operating system at the third virtual machine. Advancing to 412, the error may be corrected at the third virtual machine. For example, the error may be corrected without affecting the first operating system at the first virtual machine and without affecting the second operating system at the second virtual machine. For example, in FIG. 1, the error 138 may be detected at the third operating system 126. The error 138 may be corrected at the third virtual machine 123 without affecting the first virtual machine 121 and the second virtual machine 122. The method then ends at 414.

Thus, virtual machines may be used to process a data stream having different content types. When an error is encountered during processing of a particular content type at one of the virtual machines, the error may be dealt with out affecting processing of the other content types at the other virtual machines.

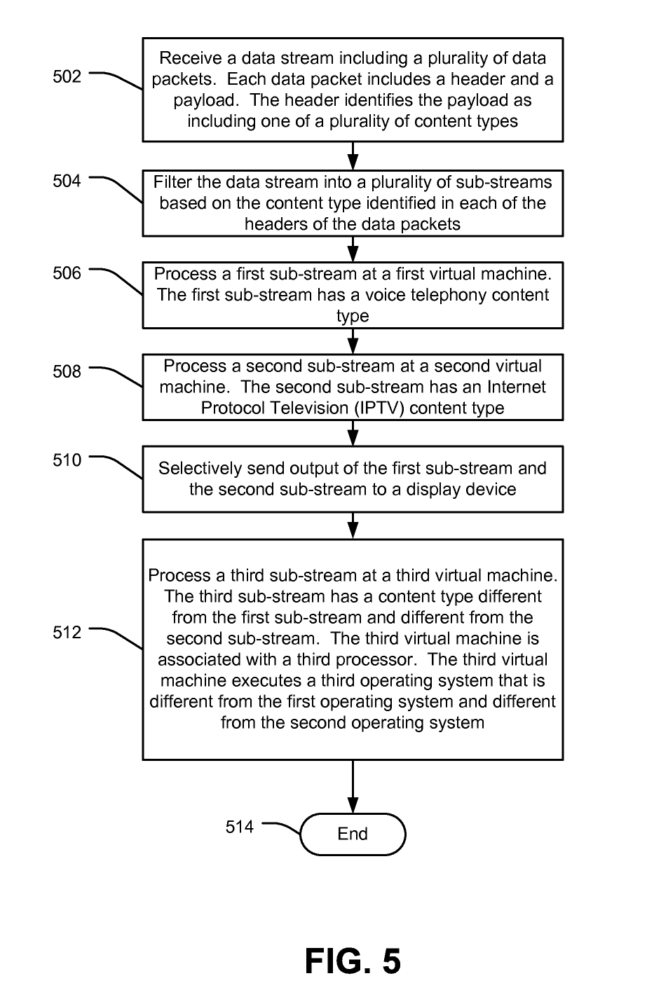

FIG. 5 is a flow diagram of a second particular embodiment of a method to process a data stream having different content types. The method of FIG. 5 may be performed by a device, such as the set-top box device 120 of FIG. 1, the display device 232 of FIG. 2, or the computing device 320 of FIG. 3.

A data stream including a plurality of data packets may be received, at 502. Each data packet may include a header and a payload. The header may identify the payload as including one of a plurality of content types. For example, the header may identify the payload as including a voice telephony content type, a media content type, a web browser content type, another content type, or any combination thereof. Moving to 504, the data stream may be filtered into a plurality of sub-streams based on the content type identified in each of the headers of the data packets. For example, data packets having a header identifying a first content type may be filtered into a first sub-stream and data packets having a header identifying a second content type may be filtered into a second sub-stream. Each sub-stream may be sent to a virtual machine for processing. Advancing to 506, a first sub-stream may be processed at a first virtual machine. The first sub-stream may have a voice telephony content type. Proceeding to 508, a second sub-stream may be processed at a second virtual machine. The second sub-stream may have an Internet Protocol Television (IPTV) content type. Advancing to 510, the output of the first sub-stream and the second sub-stream may be selectively output to a display device. For example, a subscriber may select whether to display one or more of the processed sub-streams at a display device. To illustrate, the subscriber may select to display media content (e.g. IPTV content) at the display device. Advancing to 512, a third sub-stream is processed at a third virtual machine. The third sub-stream may have a content type different from the first sub-stream and different from the second sub-stream. For example, the third sub-stream may have a web browser content type. The third virtual machine may be associated with the third processor. For example, in FIG. 3, the first sub-stream 350 may be processed at the first virtual machine 321 that is associated with the first processor 327. The second sub-stream 351 may be processed at the second virtual machine 322 that is associated with the second processor 328. The third sub-stream 352 may be processed at the third virtual machine 323 that is associated with the third processor 329. The third virtual machine may execute a third operating system that is different from the first operating system and different from the second operating system. The method then ends at 514.

Thus, by using virtual machines to process a data stream having different content types, each virtual machine may execute a different operating system. For example, each operating system at each virtual machine may be optimized to process a particular content type.

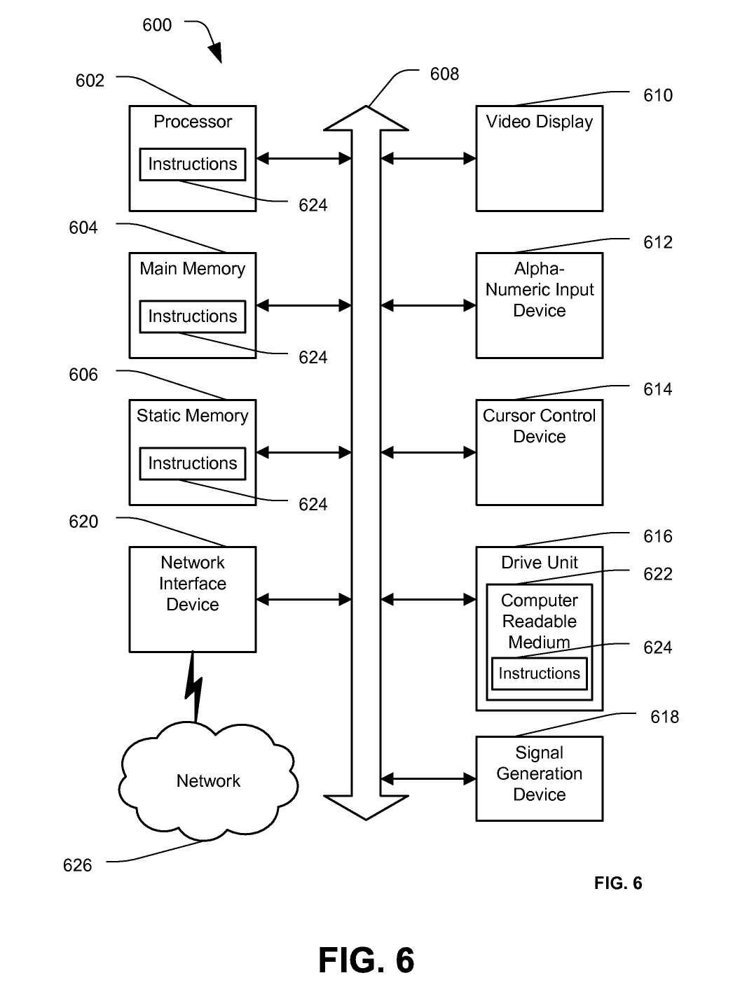

Referring to FIG. 6, an illustrative embodiment of a general computer system is shown and is designated 600. The computer system 600 can include a set of instructions that can be executed to cause the computer system 600 to perform any one or more of the methods or computer based functions disclosed herein. The computer system 600, or any portion thereof, may operate as a standalone device or may be connected, e.g., using a network, to other computer systems or peripheral devices. The computer system 600 may be used to implement the set-top box device 120 of FIG. 1, the display device 232 of FIG. 2, the computing device 320 of FIG. 3, or any combination thereof.

In a networked deployment, the computer system 600 may operate in the capacity of a set-top box device, a residential gateway, or a server, such as a media content server as described above with reference to FIGS. 1-4. The computer system 600 can also be implemented as or incorporated into various devices, such as a personal computer (PC), a tablet PC, a personal digital assistant (PDA), a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

As illustrated in FIG. 6, the computer system 600 may include a processor 602, e.g., a central processing unit (CPU), a graphics-processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid-state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624, e.g. software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any tangible storage medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any one or more of a computer-readable medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. The software may also utilize a signal including computer instructions.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, VoIP, IPTV, MPEG, SMPTE, and H.264) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the disclosure is to be determined by the broadest permissible interpretation of the following claims and their equivalents, and shall not be restricted or limited by the foregoing detailed description.

What is claimed is:

1. A computer implemented method, comprising:
receiving a data stream at a set-top box device from a residential gateway, the data stream comprising first data having a first content type, second data having a second content type, and third data having a third content type;
assigning the first data for processing at a first machine of the set-top box device;
assigning the second data for processing at a second machine of the set-top box device; and
assigning the third data for processing at a third machine of the set-top box device;
wherein the set-top box device is configured to selectively output at least one of the first data, the second data, and the third data for display at a display device.

2. The computer implemented method of claim 1, wherein the data stream comprises a plurality of data packets, wherein each data packet comprises a header and a payload, and wherein each header identifies the payload as including one of the first content type, the second content type, and the third content type.

3. The computer implemented method of claim 1, wherein the first content type is a voice telephony content type, wherein the second content type is a multimedia content type, and wherein the third content type is an internet browser content type.

4. The computer implemented method of claim 1, wherein the first virtual machine executes a first operating system, wherein the second virtual machine executes a second operating system, and wherein the third virtual machine executes a third operating system.

5. The computer implemented method of claim 4, further comprising:
detecting an error when executing the first operating system at the first virtual machine; and
correcting the error at the first virtual machine without affecting the second operating system at the second virtual machine and without affecting the third operating system at the third virtual machine.

6. The computer implemented method of claim 5, wherein correcting the error at the first virtual machine comprises restarting the first operating system.

7. A display device, comprising:
at least one processor;
a memory coupled to the at least one processor;
an input interface configured to receive a data stream comprising a plurality of data packets, wherein each data packet comprises a header and a payload, and wherein the header identifies the payload as including one of a plurality of content types;
a management module stored at the memory, the management module executable by the at least one processor to assign a first content type of the plurality of content types to a first virtual machine and to assign a second content type of the plurality of content types to a second virtual machine; and
an output interface to selectively output at least one of the content types to a display screen.

8. The display device of claim 7, wherein the first content type comprises Voice over Internet Protocol (VoIP) data.

9. The display device of claim 8, wherein the second content type comprises Internet Protocol Television (IPTV) data.

10. The display device of claim 9, wherein the management module is further executable by the at least one processor to assign a third content type of the plurality of content types to a third virtual machine, wherein the third virtual machine includes a HyperText Markup Language (HTML) browser.

11. The display device of claim 10, wherein the management module is further executable by the at least one processor to correct an error detected at the second virtual machine.

12. The display device of claim 11, wherein the management module is further executable by the at least one processor to correct the error detected at the second virtual machine by removing a malicious application received via the data stream.

13. The display device of claim 11, wherein the management module is further executable by the at least one processor to correct the error detected at the second virtual machine by terminating at least one executing process within the second virtual machine without restarting the second virtual machine.

14. A computer-readable storage medium comprising operational instructions, that when executed by at least one processor, cause the at least one processor to:
receive a data stream comprising a plurality of data packets, wherein each data packet comprises a header and a payload, and wherein the header identifies the payload as including one of a plurality of content types;
filter the data stream into a plurality of sub-streams based on the content types identified in headers of the data packets;
process a first sub-stream at a first machine, the first sub-stream having a voice telephony content type;
process a second sub-stream at a second machine, the second sub-stream having an Internet Protocol television (IPTV) content type; and
selectively send output of the first sub-stream and the second sub-stream to a display device.

15. The computer-readable storage medium of claim 14, wherein the first machine is associated with a first processor.

16. The computer-readable storage medium of claim 15, wherein the second machine is associated with a second processor.

17. The computer-readable storage medium of claim 16, wherein the first machine executes a first operating system.

18. The computer-readable storage medium of claim 17, wherein the second machine executes a second operating system that is different from the first operating system.

19. The computer-readable storage medium of claim 18, wherein the operational instructions, when further executed by the at least one processor, cause the at least one processor to process a third sub-stream at a third machine, the third sub-stream having a content type different from the first sub-stream and different from the second sub-stream, wherein the third machine is associated with a third processor.

20. The computer-readable storage medium of claim 19, wherein the third machine executes a third operating system that is different from the first operating system and different from the second operating system.
